(19) United States
(12) Patent Application Publication
(10) Pub. No.: US 2012/0103473 A1
(43) Pub. Date: May 3, 2012

(54) METHOD FOR CARBONITRIDING

(76) Inventors: Lothar Foerster, Stuttgart (DE); Jochen Schwarzer, Witten (DE); Laszlo Hagymasi, Gerlingen (DE); Thomas Waldenmaier, Freiberg/Neckar (DE)

(21) Appl. No.: 13/319,314

(22) PCT Filed: Mar. 18, 2010
(86) PCT No.: PCT/EP10/53559

§ 371 Date: Jan. 19, 2012

(30) Foreign Application Priority Data
May 11, 2009 (DE) 10 2009 002 985.0

(51) Int. Cl. C23C 8/34; B32B 15/04

(52) U.S. Cl. 148/206; 148/317

(57) ABSTRACT

In a method for carbonitriding at least one metal part, the metal part is heated in a heating phase to a treatment temperature, is nitrided in at least one nitriding phase using a nitrogen donor gas, and is carburized in at least one carburizing phase using a carbon donor gas. The first nitriding phase begins after the termination of the heating phase and before the beginning of the first carburizing phase.

### BACKGROUND OF THE INVENTION

1. Field of the Invention

The present invention relates to a method for carbonitriding at least one metal part.

2. Description of Related Art

Methods for carbonitriding of metal parts are known from published German patent application documents DE 199 09 694 A1, DE 101 18 494 A1 and DE 103 22 255 A1.

Published German patent application document DE 199 09 694 A1 describes a carbonitriding method in which the diffusion in of the nitrogen takes place during the entire process or in response to the use of nitrogen as the donor gas, preferably by itself, in the last process phase.

Published German patent application document DE 101 18 494 C2 describes a low-pressure carbonitriding method in which steel parts are first carburized and subsequently nitrided using a nitrogen donor gas.

Published German patent application document DE 103 22 255 A1 describes a method for carburizing steel parts, in which both during the heating phase and during the diffusion phase nitrogen-evolving gas is added.

By nitriding after or during the last carburizing phase, however, nitrogen is enriched only in a region close to the surface, which has a lesser depth than the carburized region. This has the result that the resistance to tempering, the hardness, the stability and the resistance to wear in the carburized region cannot be sufficiently increased.

Nitriding during the heating phase, on the other hand, leads to an inhomogeneous resistance to tempering, hardness, stability and/or resistance to wear within the metal part or within one batch of metal parts.

Thus, the present invention is based on the object of providing a method for carbonitriding metal parts, using which the resistance to tempering and/or the hardenability of a metal part is able to be improved and/or a nitriding depth comparable to the carburizing depth is able to be achieved.

### BRIEF SUMMARY OF THE INVENTION

In the method according to the present invention for carbonitriding at least one metal part, the metal part is heated in a heating phase to a treatment temperature, is nitrided in at least one nitriding phase using a nitrogen donor gas, and is carburized in at least one carburizing phase using a carbon donor gas, and wherein the first nitriding phase begins after the termination of the heating phase and before the beginning of the first carburizing phase.

The fact that the nitriding phase begins only after the termination of the heating phase has the advantage that temperature gradients within the metal part or within a batch of a plurality of metal parts are able to be reduced, and because of that, an inhomogeneous resistance to tempering, hardness, stability and/or resistance to wear within the metal part or within a batch of metal parts is able to be avoided.

The fact that the first carburizing phase is begun only after the beginning of the nitriding phase has the advantage that the nitrogen introduced into the surface of the metal part is able to diffuse into the metal part over the entire further treatment duration, and contributes to the increase in the resistance to tempering, the hardness, the stability and the resistance to wear at the edge zone.

Over and above that, because the first carburizing phase is begun only after the beginning of the nitriding phase, the nitrogen diffusion and the carbon diffusion are sped up. The reason for this is that nitrogen atoms and carbon atoms are able to occupy the same interstitial sites in the crystal lattice of the metal. Upon the execution of a carburizing phase subsequently to a nitriding phase, interstitial sites close to the surface, that are becoming free, are able to be occupied by carbon atoms, and thus the effusion of nitrogen atoms, and the nitrogen diffusion to the surface, connected with it, is made more difficult. Because of that, using the proposed process management, a reduction may also be achieved in the nitrogen effusion occurring and known in the low pressure region.

Furthermore, because of the early nitrogen supply, the nitrogen is able to be introduced relatively deeply into the edge layer of the metal part, for instance, up to 1.5 mm or even up to 6 mm. Because of that, in metal parts, having an operating temperature such as up to 300° C. or even up to 350° C., an increase in the resistance to tempering may be achieved in the edge region, a sufficient hardness, stability and/or resistance to wear may be reached and/or a long-term functioning of the metal part may be ensured.

Moreover, using the method according to the present invention, an edge carbon concentration of≧0.3 mass per cent to≦0.7 mass per cent or even of up to 1 mass per cent, and an edge nitrogen concentration of≧0.1 mass per cent to≦0.35 mass per cent or even of up to 0.5 mass per cent may be achieved. In order to increase the resistance to tempering, the hardness, the stability and/or the resistance to wear, in the region of the carburizing depth, for instance, up to 1.5 mm or even up to 6 mm deep, a nitrogen concentration of at least 0.05 mass per cent, possibly of at least 0.15 mass per cent may advantageously be reached.

In particular, the method according to the present invention may be used for carbonitriding the edge layer of a metal part. The method according to the present invention may also be used for carbonitriding a plurality of metal parts. For example, the method according to the present invention may be used for carbonitriding one or more metallic tools.

The metal of the metal part may be both a metal and a metal alloy, such a steel.

Within the scope of an additional specific embodiment of the method according to the present invention, the first nitriding phase ends, particularly directly before the first carburizing phase or during the first carburizing phase or along with the first carburizing phase or after the first carburizing phase. Because the first carburizing phase follows directly upon the nitriding phase or runs at least partially simultaneously with the first nitriding phase, the nitrogen effusion is able to be reduced or prevented during additional carburizing phases, additional nitriding phases or diffusion phases.

Furthermore, the method according to the present invention is able to have at least one second nitriding phase. This may run, for instance, after the first carburizing phase. In particular, the second nitriding phase may begin following upon the first carburizing phase.

Within the scope of an additional specific embodiment of the method according to the present invention, between the heating phase and the first nitriding phase, the method has a temperature evening-out phase, in which the treatment temperature is held constant for the evening-out of the temperature in the metal part or among several metal parts, particularly at a constant atmosphere. In this instance, by a constant atmosphere both a vacuum and a preferably inert gas atmosphere, having a constant pressure and a constant composition, may be understood. The temperature evening-out phase may run following upon the heating phase, in particular. The first nitriding phase, in turn, may run following upon the temperature evening-out phase. The temperature evening-out phase may last, for instance, at least 5 min, in particular 30 min. A temperature evening-out phase has the advantage that temperature gradients within the metal part or within a batch of a plurality of metal parts are able to be reduced further, and because of that, an inhomogeneous resistance to tempering, hardness, stability and/or resistance to wear within the metal part or within a batch of metal parts is able to be avoided further.

In the phases following the temperature evening-out phase, for example, nitriding phases, carburizing phases and/or diffusion phases, the treatment temperature may further be held constant, especially at the same treatment temperature as in the temperature evening-out phase. However, increasing or dropping the temperature in a subsequent treatment phase is conceivable.

Within the scope of an additional specific embodiment of the method according to the present invention, the method is carried out in a treatment chamber that is particularly able to be evacuated.

Within the scope of another additional specific embodiment of the method according to the present invention, the method has at least one diffusion phase, in which the treatment chamber is evacuated and/or filled with an inert gas, such as argon. The first diffusion phase may run, for instance, between the first nitriding phase and the first carburizing phase, or between the first carburizing phase and the second nitriding phase.

Within the scope of yet another additional specific embodiment of the method according to the present invention, besides the first nitriding phase, has at least one additional nitriding phase and/or, besides the carburizing phase, has at least one additional carburizing phase and/or, besides the first diffusion phase, has at least one additional diffusion phase. The additional nitriding phases and/or the additional carburizing phases may run, particular, directly one after the other, alternatingly, for instance, and also partially or completely at the same time. Because of nitriding phases and carburizing phases that run simultaneously or one after another, the carbon diffusion and the nitrogen diffusion in the microstructure of the metal part may be advantageous increased. Moreover, between the additional nitriding phases and/or additional carburizing phases, additional diffusion phases may run. For example, an additional carburizing phase may begin during or subsequently to an additional nitriding phase, or an additional nitriding phase may begin during or subsequently to a carburizing phase. At the close of these two phases, an additional diffusion phase may then begin, for example.

Within the scope of a further additional specific embodiment of the method according to the present invention, the nitrogen donor gas includes a compound, selected from the group made up of ammonia, nitrogen and mixtures of these, especially ammonia. In particular, the nitrogen donor gas may be made up of a compound, selected from the group made up of ammonia, nitrogen and mixtures thereof, especially ammonia.

Within the scope of a further additional specific embodiment of the method according to the present invention, the carbon donor gas includes a compound, selected from the group made up of acetylene, ethylene, propane, propene, methane and mixtures of these. In particular, the carbon donor gas may be made up of a compound, selected from the group made up of acetylene, ethylene, propane, propene, methane and mixtures thereof.

Within the scope of still an additional specific embodiment of the method according to the present invention, the method is a low-pressure carbonitriding method.

Within the scope of an additional specific embodiment of the method according to the present invention, the treatment temperature is in a range of≧780° C. to≦1050° C., particularly of≧780° C. to≦950° C.

Within the scope of an additional specific embodiment of the method according to the present invention, during the nitriding phases, a nitrogen donor gas partial pressure of less 500 mbar is present, especially of less than, or equal to 50 mbar, for instance, of less than 20 mbar. During the carburizing phases, there may be a carbon donor gas partial pressure of less than 300 mbar, particularly of less than 20 mbar, for instance, of less than 10 mbar.

In order to compensate for nitrogen losses by nitrogen effusion during a diffusion sequence, during or before a nitriding phase, particularly one introduced before the diffusion phase, the temperature may be adjusted/increased, for instance, to a temperature within the range of 840° C. to 950° C.; and/or the nitrogen supply may be increased, for instance, by increasing the nitrogen donor gas partial pressure, to 50 mbar or 30 mbar, for example, and/or increasing the nitrogen donor gas volume throughput, for instance, to 3000 l/h. In this way, the nitrogen concentration in the region near the surface may be set, for instance, from≧0.1 mm to≦0.2 mm, or even from up to 0.3 mm, higher than in the end product, and a nitrogen effusion is able to be compensated for. Now, if the nitrogen concentration is reduced in a subsequent diffusion phase because of nitrogen effusion, and decreases, for example, to an edge nitrogen concentration of 0.5 mass per cent or, for example, to 0.1 mass per cent to 0.35 mass per cent, an increase in resistance to tempering and hardenability may advantageously be ensured at the surface anyway.

One further subject matter of the present invention is a metal part, for instance, a metallic workpiece, in which the nitriding depth is greater than the carburizing depth. Such a metal part is able to be produced by the method according to the present invention. The advantage is, in this context, that the component is able to have a deep-reaching supporting effect under mechanical stress, at increased operating temperatures.

One further subject matter of the present invention is a metal part, for instance, a metallic workpiece, produced by a method according to the present invention. In particular, in such a metal part, the nitriding depth may be greater than the carburizing depth.

### BRIEF DESCRIPTION OF THE DRAWINGS

FIG. 1 shows a graph for the schematic illustration of a specific embodiment of the method according to the present invention.

### DETAILED DESCRIPTION OF THE INVENTION

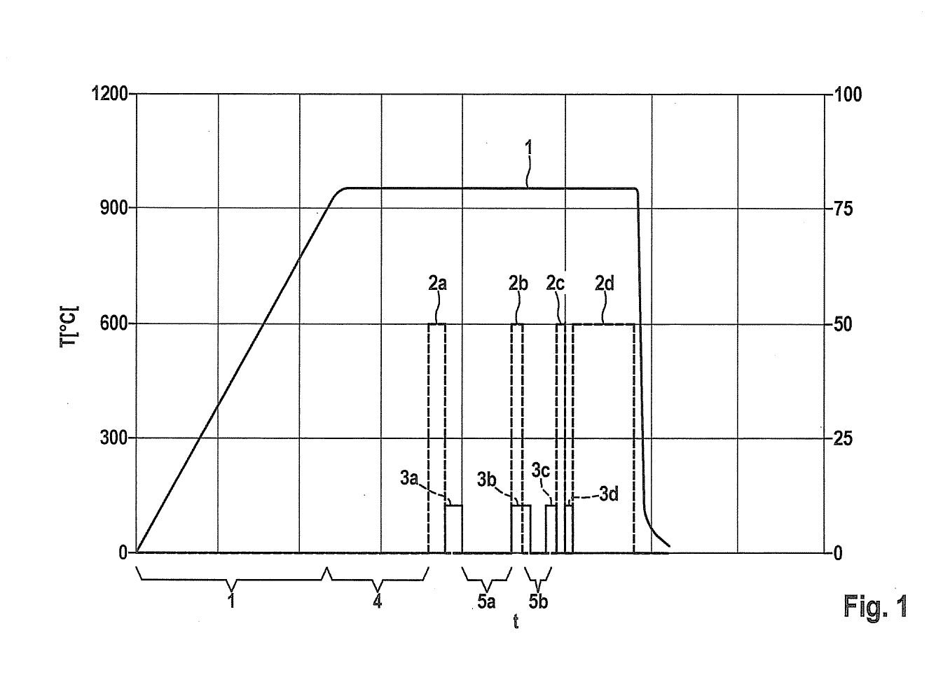

Within the scope of the specific embodiment shown in FIG. 1, the method includes a heating phase 1, a temperature evening-out phase 4, four nitriding phases 2a, 2b, 2c, 2d, four carburizing phases 3a, 3b, 3c, 3d and two diffusion phases 5a, 5b.

FIG. 1 shows that, during heating phase 1, the temperature is increased continuously at a constant heating rate to a treatment temperature of about 950° C.

In temperature evening-out phase 4, the treatment temperature is held constant to about 950° C. During heating phase 1 and temperature evening-out phase 4, in this context, neither a nitrogen donor gas nor a carbon donor gas is supplied.

In the first nitriding phase 2a that follows temperature evening-out phase 4, a nitrogen donor gas, such as ammonia, is supplied at a nitrogen donor gas partial pressure of approximately 50 mbar. The treatment temperature, same as in the following nitriding phases 2b, 2c, 2d, carburizing phases 3a, 3b, 3c, 3d and diffusion phases 5a, 5b, is held constant at approximately 950° C. A first carburizing phase 3a follows first nitriding phase 2a, in the former the nitrogen donor gas partial pressure is dropped again to 0 mbar, and the carbon donor gas partial pressure is raised to about 10 mbar. After first carburizing phase 3a, there follows a first diffusion phase 5a, in which the carbon donor gas partial pressure is dropped again to 0 mbar. This may be done, for example, by evacuating the treatment chamber or by filling the treatment chamber with an inert gas.

A second carburizing phase 3b follows the first diffusion phase 5a, the former having a carbon donor gas partial pressure of approximately 10 mbar and a second nitriding phase 2b having a nitrogen donor gas partial pressure of about 50 mbar. FIG. 1 shows that second carburizing phase 3b and second nitriding phase 2b begin at the same time. Second carburizing phase 3b is longer, however, than second nitriding phase 2b, and therefore ends only after nitriding phase 2b. In the time period in which both phases 2b, 3b run simultaneously, there is a carbon donor gas partial pressure of about 10 mbar and a nitrogen donor gas partial pressure of about 50 mbar. Upon termination of second nitriding phase 2b, the nitrogen donor gas partial pressure is, however, lowered to 0 mbar and the carbon donor gas partial pressure of approximately 10 mbar is maintained to the end of second carburizing phase 3b. Upon second carburizing phase 3b there follows a second diffusion phase 5b, in which the carburizing donor gas partial pressure is dropped again to 0 mbar.

Upon second diffusion phase 5b, in turn, there follows a third carburizing phase 3c having a carbon donor gas partial pressure of approximately 10 mbar. Upon termination of third carburizing phase 3c, the carbon donor gas partial pressure is dropped to 0 mbar, and a third nitriding phase 2c runs, having a nitrogen donor gas partial pressure of about 50 mbar. The latter is followed again by a fourth carburizing phase 3d in which the nitrogen donor gas partial pressure is dropped to 0 mbar, and the carbon donor gas partial pressure is raised to about 10 mbar. After termination of fourth carburizing phase 3d, the carbon donor gas partial pressure is dropped again to 0 mbar, and a fourth nitriding phase 2d runs, having a nitrogen donor gas partial pressure of about 50 mbar, which is very long compared to previous nitriding phases 2a through 2c. After this last nitriding phase 2d, the treatment temperature of 950° C. is no longer maintained, and quenching to room temperature is carried out, in order to set the desired microstructure composition.

It is self-evident that, in this way, numerous methods of carbonitriding are possible, and the present invention is not restricted to the sequence explained and the number of 4 nitriding phases 2a, 2b, 2c, 2d, four carburizing phases 3a, 3b, 3c, 3d and two diffusion phases 5a, 5b.

1-13. (canceled)

14. A method for carbonitriding at least one metal part, comprising:
heating the metal part in a heating phase to a treatment temperature;
nitriding the metal part in a first nitriding phase using a nitrogen donor gas; and
carburizing the metal part in a first carburizing phase using a carbon donor gas;
wherein the first nitriding phase begins after the termination of the heating phase and before the beginning of the first carburizing phase.

15. The method as recited in claim 14, wherein the first nitriding phase one of:
(i) ends before the first carburizing phase; (ii) during the first carburizing phase; (iii) with the first carburizing phase; or (iv) after the first carburizing phase.

16. The method as recited in claim 14, further comprising:
a temperature evening-out phase between the heating phase and the first nitriding phase, wherein during the temperature evening-out phase the treatment temperature is held constant for the evening-out of the temperature within the at least one metal part at a constant atmosphere.

17. The method as recited in claim 14, wherein the method is performed in a treatment chamber configured to be evacuated.

18. The method as recited in claim 17, further comprising:
a first diffusion phase during which the treatment chamber is at least one of evacuated and filled using an inert gas.

19. The method as recited in claim 18, further comprising:
at least one of: (i) a further nitriding phase in addition to the first nitriding phase; (ii) a further carburizing phase in addition to the first carburizing phase; and (iii) a further diffusion phase in addition to the first diffusion phase.

20. The method as recited in claim 14, wherein the nitrogen donor gas includes at least one of ammonia and nitrogen.

21. The method as recited in claim 20, wherein the carbon donor gas includes at least one of acetylene, ethylene, propane, propene and methane.

22. The method as recited in claim 14, wherein the method is a low-pressure carbonitriding method.

23. The method as recited in claim 14, wherein the treatment temperature is in a range of≧780° C. to≦1050° C.

24. The method as recited in claim 23, wherein a nitrogen donor gas partial pressure of less than 500 mbar is present during the nitriding phase.

25. A metal part, comprising:
a nitrided portion having a nitriding depth;
a carburized portion having a carburizing depth, wherein the nitriding depth is greater than the carburizing depth.
